(19) United States
(12) Patent Application Publication
(10) Pub. No.: US 2007/0150357 A1
(43) Pub. Date: Jun. 28, 2007

(54) Electronic commerce method using combined publicity according to goods/service type and computer readable recording media storing program for executing the same

(76) Inventor: Yong-Gyun Shin, Incheon (KR)

Correspondence Address: JONES DAY, 222 EAST 41ST ST, NEW YORK, NY, 10017, US

(21) Appl. No.: 10/551,911

(22) PCT Filed: Apr. 1, 2003
(86) PCT No.: PCT/KR03/00649

§ 371 Date: Sep. 13, 2006

(51) Int. Cl. G06Q 30/00

(52) U.S. Cl. 705/26

(57) ABSTRACT

Electronic commerce method using combined publicity according to goods/service type includes the steps of refer-ring to a unique communication code or a detailed product/service code input by a client accessing a central service provider server to read corresponding product/service information; transmitting order-related information to a specific member store terminal; delivering the ordered product/service to an address of recipient together with combined public information and a publicity item from the member store; and receiving and managing information related to the delivery. This method may reduce costs for publicity due to the combined publicity and the gift as well as raise interest in the publicity media by inducing customers to participate in events, and it also ensures convenience in ordering.

### TECHNICAL FIELD

The present invention relates to an electronic commerce method using systems connected through a network such as Internet or PSTN (Public Switched Telephone Network), and more particularly to an electronic commerce method capable of promoting sales by means of combined publicity according to goods/service types with the use of publicity items which are provided to users for combined publicity or gratitude expression when a product is ordered or delivered according to a unique communication code or a detailed goods/service code set according to the goods/service types, through a communication network system which connects a central service provider server, member store terminals, client terminals and recipient terminals.

### BACKGROUND ART

Currently, various merchants or service providers who sell or provide goods and service on/off line generally give public information related to goods or service and related to stores managed by them to consumers independently through various advertisement means such as a public relations magazine, radio or TV broadcasting, and the like. However, if the service providers located at various regions should conduct publicity activities independently through the conventional various publicity means, too excessive publicity costs are required. However, the most service providers are reluctant to spend the cost.

Recently, as a super-high speed communication network is widely propagated together with the spread of computer and the development of the computer communication technique, the trend of computer usage is so rapidly diffused that 5 Internet is ordinarily used even in a home. If various communication networks such as Internet or PSTN can be used to classify business, human and renters dispersed in various regions into several groups according to the kind of goods or service and then give the combined publicity of business entities in one group dealing with the same kind of goods or service through an integrated publicity medium, the material and human costs required for publicity may be apparently reduced. But, the publicity effect for raising profit of each service provider through the combined publicity might be substantially changed depending on its implementing method, for example using lottery tickets for combined sales.

There are proposed many kinds of methods for maximizing the publicity effects by means of the combined publicity generated in the commercial transaction relation, particularly in the electronic commerce method using the communication network system recently developed.

As a prior art proposed in the past, Korean Patent Filing No. 2001-0031785 (published in Dec. 18 2002) discloses “A system for connecting a representative phone number according to business, function and administrative civil petition, and a computer-readable storing medium storing a computer program for executing the method”, and Korean Patent Filing No. 2000-0046675 (published in Nov. 6, 2000) discloses “Automatic connection apparatus and method between a user and a member store using a representative phone number according to business”. In addition, many service providers such as a restaurant manager make publicity papers with spending a lot of marketing costs to publicize himself/herself, and consumers generally keep such papers. Thus, when ordering a product or receiving a desired service, a consumer checks a phone number from the publicity papers to request a service, or uses 1588 service (which is a kind of communication service in Korea) using a representative phone number according to business, which are also included as a category of the known prior art.

However, since the prior art of the former reference classifies nationwide representative phone numbers according to business, function and administrative civil petition and then diverts a call received in the representative phone number to a phone number of a regional service provider of the same kind, an information user in a region may easily connect to an adjacent service provider just by calling the representative phone number according to business, function and administrative civil petition, and a regional service provider may gain a profit because he/she may always receive a phone call of a caller who wants to purchase a product dealt by him/her. However, the phone call ordering is not a unique way for ordering and delivering a product, and if an ordered spot is not coincident to a delivering spot, the technique of connecting the phone call to the nearest service provider with reference to the caller information even causes a problem in delivery. In addition, it is not considered that this technique directly affects on the publicity of the regional service provider. Meanwhile, the conventional technique of the later document is related to a service that, when a consumer makes a call to a representative phone number endowed to each business, the call is connected to a member store nearest to the consumer by using caller tracking and GIS (Geographical Information System). This technique does not also gives an active solution to the above problems. In addition, the technique requires a separate program or hardware for using GIS, so it is not recognized as an optimized commercial transaction method. In the third method proposed above, a consumer should make an ordering call to an independent service provider after checking the phone number one by one, which is very cumbersome to the consumer.

### DISCLOSURE OF INVENTION

The present invention is designed on the ground of technical endeavor and efforts to solve the problems of the above advertisement method using a representative phone number on/off line conducted by a service provider who handling goods or service, relieve inconvenience of a consumer for checking a business entity through a phone number, solve troubles of a consumer for ordering different kinds of goods or service independently to each service provider with a respective communication means, and raise a profit of a service provider by reducing costs and time for publicity and maximizing publicity effects.

In order to accomplish the above object, the present invention provides an electronic commerce method for combined publicity according to the kind of goods or service by using a publicity item for combined publicity and gratitude expression, which is provided to a consumer when ordering or delivery is conducted according to a unique communication code and a detailed goods/service code set according to the kind of goods/service through a communication network system for connecting a central service provider server, member store terminals, client terminals and recipient terminals, wherein the method includes the steps of (a) interworking the central service provider server to a database storing goods/service information corresponding to the unique communication code and the detailed goods/service code and a database in which client information, member store information and recipient information are classified; (b) reading corresponding goods/service information from the database interworked with the central service provider system with reference to a predetermined unique communication code or detailed goods/service code input from the client terminal connected to the central service provider server through the communication network; (c) checking the goods/service information read by the client terminal, then if order-related information including an address for delivery is input for a specific goods/service, storing the input order-related information to a database classified by the client information and a database classified by the member store information which is referred in relation to the address for delivery of the order-related information respectively, and then transmitting the order-related information to a selected one of the member store terminals; (d) the member store terminal delivering the ordered goods/service to the address for delivery of a designated recipient with reference to the order-related information and providing a publicity item for the combined publicity and gratitude expression together, and registering delivery completion information and publicity item-related information in a database interworked with the central service provider server; and (e) the recipient terminal, which receives the publicity item for combined publicity and gratitude expression, registering information related to the publicity item in a database interworked with the central service provider server.

It is apparent that the aforementioned electronic commerce method using combined publicity according to the kinds of goods or service may be realized by a program executable by a computer. Thus, another object of the invention is to provide various storage media in which a program, possibly included in an equivalent group in aspect of business prosecution and technology, is stored. That is to say, the electronic commerce method using combined publicity according to the kinds of goods or service may be stored in a storage medium readable by a computer, or included in a cellular phone in order to give convenience to a user so that the user may search and order a desired goods or service according to the kind of goods or service though not knowing a unique communication code for the goods or service. More preferably, the program may be stored in a storage medium managed by a server computer in the server/client computer system. This storage medium includes all kinds of storage media which stores programs or data so that they may be read out by a computer system. For example, a chip included in a cellular phone, ROM (Read Only Memory), RAM (Random Access Memory), CD-ROM (Compact Disk ROM), DVD-ROM (Digital Video Disk ROM), magnetic tape, floppy disk, optical data storage and the like may be used as the storage medium. In addition, the storage medium may also be realized in a type of carrier wave (for example, transmission through Internet). Moreover, this storage medium may be distributed and executed in computer systems connected through a network with keeping a code for the computer to read. Thus, the storage medium storing a program which may directly or indirectly executing the method of the present invention should be protected, and separated claimed in the appended claims.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic diagram showing a communication network according to one embodiment of the present invention;

FIG. 2 is a singular communication code table according to the kind of goods or service, used in one embodiment of the present invention; and

FIGS. 3 and 4 are front and rear views of a publicity ticket for lottery-type combined publicity and gratitude expression according to one embodiment of the present invention.

### BEST MODES FOR CARRYING OUT THE INVENTION

Hereinafter, preferred embodiments of the present invention will be described in detail with reference to the accompanying drawings.

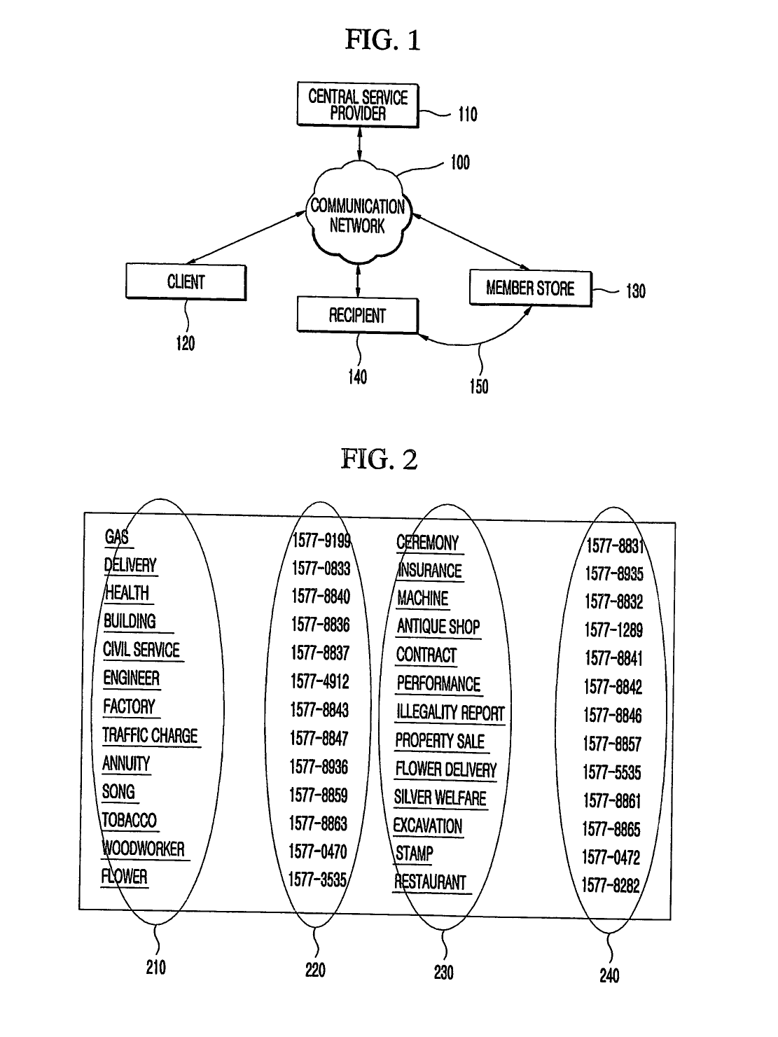

FIG. 1 shows a communication network according to one embodiment of the present invention.

Referring to FIG. 1, a central service provider 110, a client 120, a member store 130 and a recipient 140, which are spatially spaced apart from each other, are interconnected through one communication network 100. At this time, it is apparent that the communication network 100 may be selected from various kinds of network systems, which enable to exchange information in real time without any spatial limit, such as a wire/wireless Internet or a wire/wireless PSTN (Public Switched Telephone Network), considering the development trend of the current communication means. Thus, the central service provider 110 is configured as a server system for managing business according to the present invention, for example including a user certification server, a database server, a program server, a communication server and so on. The central service provider 110 endows a unique communication code to each kind of goods or service and interworks with a database in which detailed goods/service information is recorded. If order-related information for a specific goods/service is input though the client terminal 120, the central service provider 110 interworks with a program server to transmit the order-related information to a member store 130, automatically determined according to delivery address information, in real time. Meanwhile, the member store 130 distributes various publicity items such as a tangible gift, an intangible service, a discount coupon, a lottery ticket and a gift certificate for the purpose of the combined publicity and gratitude expression to the recipient 140 when delivering the goods/service on/off line 150. When receiving the publicity item, the recipient 140 accesses the central service provider 110 with its terminal, and then inputs predetermined information stated in the received publicity item so as to register the publicity item for the combined publicity and gratitude expression. After that, the central service provider 110 makes a thank-you event to the recipient having the publicity item, or determines a winner by a lottery method and awards a prize to a winner according to a predetermined promise. At this time, the central service provider 110 preferably gives a differentiated prize to a winner when the winner is a recipient who directly registers the publicity item through the communication network such as Internet and then presents the publicity item having a winning lottery number. This may promote interests to the publicity item for combined publicity and gratitude expression according to the present invention.

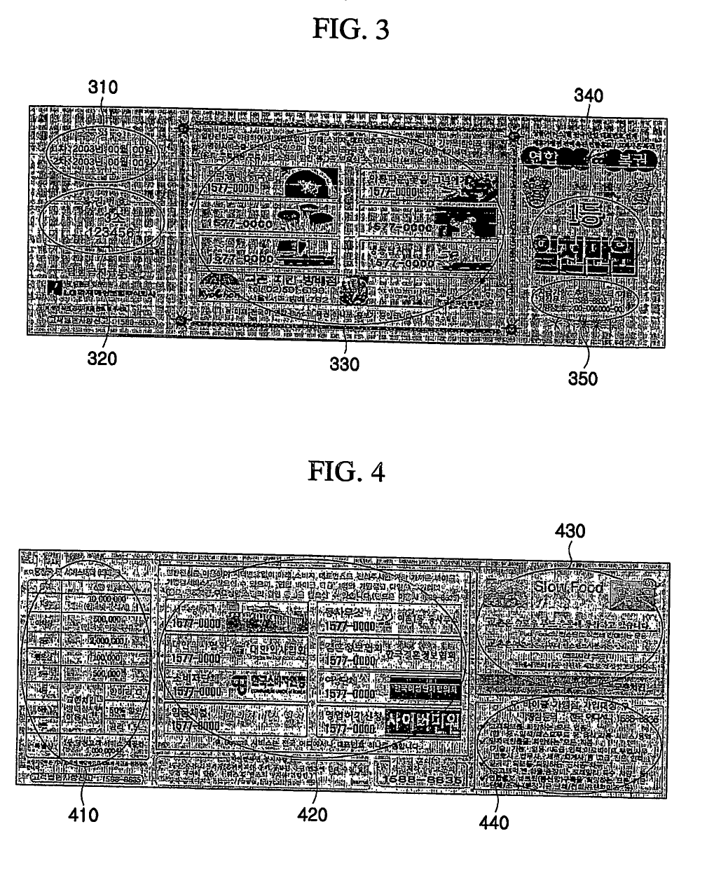

FIG. 2 shows a unique communication code table according to goods or service according to one embodiment of the present invention.

Referring to FIG. 2, it is understood that a unique communication code 220 or 240 is endowed to each kind of goods or service. Of course, it is apparent that the unique communication code for each kind of goods or service shown in FIG. 2 is just arbitrarily selected by the inventor as an example. As shown in FIG. 2, the method for endowing a unique communication code to goods or service is already widely used, for example, 119 for emergency relief service and 112 for a crime report in Korea. In this point of view, if a consumer may automatically make a call to a service provider handling a predetermined goods or service or a specific store nearest to an address of a recipient of the goods or service though he/she does not know a contact way to a business entity when ordering the goods or service, the consumer may more conveniently make an order. In addition, the individual service provider may also make concentrated publicity in connection to the unique communication code endowed to each goods or service. Thus, it is apparent that the unique communication code allows more effective publicity effects to attract interests from consumers in at least a regional market area than the conventional consumptive publicity method. Meanwhile, in case a manufacturer directly publicizes information related to a specific goods or service through a unique communication code, the publicity effect is automatically propagated to regional member stores, and it may contribute to making more jobs in relation to the goods or service. For example, if a manufacturer of a product named “Jade Floor (a trademark related to floor products)” advertises a unique communication code having a direct relation to “Jade Floor” when making an advertisement directly to final consumers by means of nationwide media such as newspapers or TV broadcast, regional sellers may be automatically connected to consumers via the unique communication code without any special publicity activity. In addition, an order made using the unique communication code is also forwarded to an engineer who installs the product, so the whole service related to the product may be rapidly completed. This is also useful for activating the regional economy.

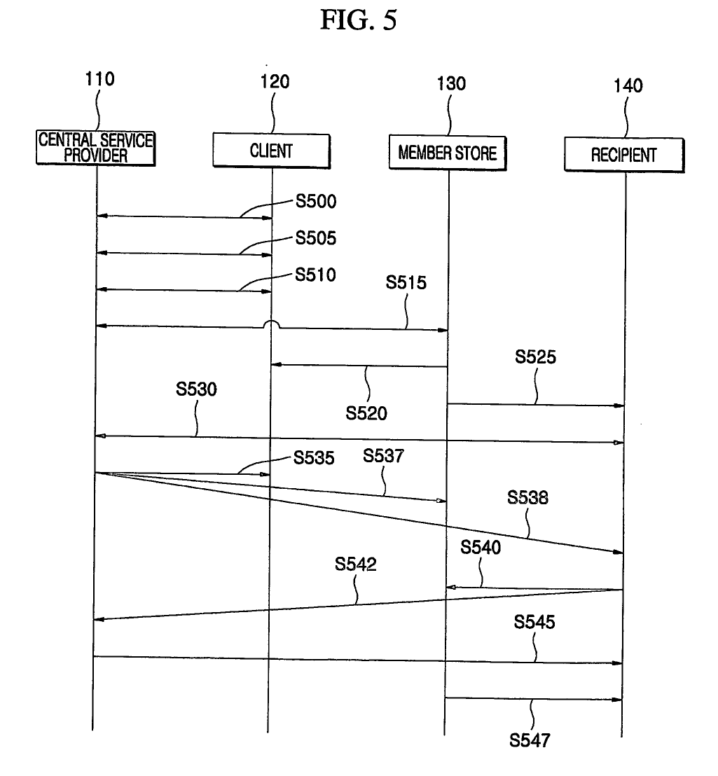

FIGS. 3 and 4 are front and rear views showing a lottery-type publicity item for combined publicity and gratitude expression according to one embodiment of the present invention.

Referring to FIG. 3, it is understood that various publicity words and lottery-related information are printed on the front surface of the publicity item for combined publicity and gratitude expression. That is to say, it is found that a lottery date region 310, a lottery number region 320, a unique communication region 330 for goods/service, a winning prize region 340 and a lottery-related information region 350 are prepared thereon. Such regions may be changed in various ways, for example some may be excluded. Moreover, there may be added other regions if required.

Referring to FIG. 4, it is found that various publicity words and lottery-related information are printed on the front surface of the lottery-type publicity item for combined publicity and gratitude expression. That is to say, it is seen that a winning prize specification region 410, a unique communication code region 420 for goods/service, a regional member store publicity word region 430 and a central service provider publicity word region 440 are distinguishably prepared thereon. Theses regions may be changed in various ways. For example, some regions may be excluded and more regions may be included therein.

The publicity item for combined publicity and gratitude expression shown in FIGS. 3 and 4 as an example is manufactured in a bundle by the central service provider and distributed to member stores at random. The member store then provides the publicity item to a recipient at a delivery address, and then conducts publicity activity for the lottery so as to attract interests on the provided publicity item. It may naturally increase relevant recognition to customers by means of the goods/service unique communication code recorded on the publicity item, thereby solving the conventional problem that a publicity medium is directly wasted. In addition, the member store publicizes that a recipient may receive a differentiated prize of more value if the recipient accesses the central service provider server and then registers the publicity item for combined publicity and gratitude expression, thereby more actively improving exposure frequency of the information recorded in the publicity item. It may maximize the publicity effect. In addition, this publicity may gradually induce a business talk or ordering for the goods or service through Internet, so a true electronic commerce may be realized. Meanwhile, if each member store prepares and delivers publicity items for combined publicity and gratitude expression by itself, too much expense will be required for management. Thus, the central service provider preferably makes in a bundle and distributes the publicity items if possible. However, if a lottery day is fixed for all publicity items, there may be caused a problem in stock. Thus, it is also possible that, when an order-related information is transmitted from the central service provider to the member store, a lottery number is generated by a random number generator and then the lottery number is output by a lottery number output unit of the member store terminal so that the member store may directly conduct the combined publicity and gratitude expression. In addition, the information such as a lottery number or a lottery date may be transmitted through the communication network not only to the member store but also directly to the client terminal or the recipient terminal. More preferably, the relevant information is transmitted on cyber so that a lottery game is executed after the publicity item for combined publicity and gratitude expression is completed.

FIG. 5 is a flowchart for illustrating an electronic commerce method according to one embodiment of the present invention.

Referring to FIG. 5, though it is shown that the central service provider 110, the client 120, the member store 130 and the recipient 140 connected through the communication network are main components, it should be understood that electronic information are interchanged between terminals or server systems which are capable of communication networking. At this time, the communication network system preferably uses wire/wireless Internet, but a wire/wireless PSTN may also be used. When the wire/wireless PSTN is used, the server of the central service provider is preferably managed by a chip included in a mobile phone, an ARS or a manned integrated call center. In addition, the communication system may also be included in a cellular phone so that a user may conveniently select goods or service with the use of IGPS (I-Global Positioning System). Meanwhile, the member store 130 (or, its terminal) is preferably operated as an independent manager mode having a Stand Alone interface interworked with the central service provider 110 (or, its server) and the client 120 (or, its terminal) respectively in real time so as to prevent overload on the communication network when many member stores or clients are connected at the same time.

First, the central service provider 110 suggests a unique communication code endowed according to the kind of goods or service as shown in the table of FIG. 3 through a web page linked to its server, and the constructs database storing goods/service information corresponding to related detailed goods/service codes and database storing member store information and recipient information so that a client may search and select a desired data (S500). At this time, the goods/service database linked to the central service provider 110 (or, its server) may be updated by a member store 130, which passes a certification process through the communication system, within a certain range. If the data related to goods or service is updated in real time, the latest goods/service information may be provided to clients.

After that, when a client 120 (or, its terminal) accesses the central service provider 110 (or, its server) and inputs a unique communication code or a detailed goods/service code, the central service provider 110 reads the corresponding goods/service information from the database with reference to the input unique communication or detailed goods/service code, and then sends the information so as to be displayed on the client terminal (S505). Then, the client 120 checks the sent goods/service information displayed on its terminal and then inputs order-related information including a delivery address for a specific goods or service (S510). Then, the central service provider 110 stores the input order-related information in the database which is distinguishable according to a member store 130 corresponding to the delivery address of the order-related information, and then sends the order-related information to the corresponding member store 130 (S515). On occasions, a step of certificating the client 120 may be further included in order to check reliability of the order (S520), which is shown as a dotted line since it is not requisite. At this time, the goods/service order-related information includes a selected goods/service code, related goods/service information, a delivery address, client information, payment information and other selected information. The order-related information may be related to one or multiple goods or service. Thus, it may solve the conventional inconvenience that a user makes an independent order through an individual shopping mall, and the client may also order and pay for all products as desired, thereby making the electronic commerce more convenient. At this time, the payment information of the order-related information is preferably information related to a payment method using any of an on-line deposit without a banknote, a credit card, a mobile phone, and account-to-account money transfer. More preferably, all kinds of payment means conducted on line may be included so that a client may conveniently pay for the purchased goods or service in a desired way. In addition, by adopting various payment types commonly used in the actual commercial transactions to pay for an ordered goods or service, the present invention may suggest various payment methods such as a prepayment of an ordering person, a post-payment of an ordering person, and a post-payment of a recipient so that the ordering person may select one of them as desired.

Meanwhile, the member store 130 delivers the ordered goods or service to the delivery address where a recipient is located with reference to the order-related information output on its terminal together with a lottery-type publicity item for combined publicity and gratitude expression (S525). And then, the member store 130 registers to the central service provider 110 (or, its server) that the goods or service and S the publicity item are delivered (S530). After that, the central service provider 110 determines a winner among the provided publicity items for combined publicity and gratitude expression by a random drawing method, and then stores a lottery result in a database and announces it on a web page linked to the central service provider server (S535, S537 and S538). At this time, the publicity item for combined publicity and gratitude expression may be one medium selected from a gift certificate, a discount coupon, and a lottery ticket for giving a prize to a winner. Meanwhile, in case the publicity item for combined publicity and gratitude expression is a lottery ticket, if a recipient or holder of a winning lottery ticket presents the publicity item to the central service provider 110 or the member store 130 (S540 or S542), a prize is awarded to the winner according to an awarding criteria previously agreed by the central service provider 110 or the member store 130 (S545 or S547). In particular, if the recipient 140 directly registers the winning publicity item for combined publicity and gratitude expression into a database, a differentiated prize is preferably awrded.

### INDUSTRIAL APPLICABILITY

According to the present invention described above, a consumer or client may be connected to a store or a business entity at a location nearest to a delivery address on the basis of goods or service just by simple connection and search using a unique communication code prepared according to the kind of goods or service, so a desired goods or service may be more rapidly provided. In particular, since the central service provider carefully selects a regional business entity (or, a store) and a regional service provider on consideration of price, quality or the like so that only a qualified regional business entity or regional service provider may be selected as a member store, the central service provider may cope with a consumer's demand. In addition, since the combined publicity of the member stores in the same business is conducted by a nationwide unique communication code without individual publicity of each business entity, a publicity expense may be reduced. Moreover, since business entities dealing the same kind of goods or service are naturally affiliated with each other through the nationwide unique communication code for each goods or service, there is no need to construct a conventional nationwide distribution network, which requires a large amount of money. This may raise the publicity effect to consumers, particularly to a product of a low recognition degree. By using the combined publicity of the business entities linked with each other according to the kind of goods or service, it is possible to clear away wasteful expenditure conventionally generated when each of business entities gives various print materials or gifts individually to consumers. In addition, it is also possible to solve the problem of the conventional concentrated service which takes a long time for ordering, business talking, delivery and recall, so the ordering, business talk, delivery and recall may be conducted rapidly at the actual place by a business entity at the nearest location selected on the basis of the delivery address, thereby improving reliability of consumers and reducing relevant costs. In particular, if the ordering and business talk for goods or service are conducted through Internet, a user should conventionally access several shopping malls dealing with the same goods or service and conduct ordering and business talk individually with the shopping malls, so harassingly. However, since the present invention constructs a database through unique communication codes for all goods/service and then connects a client to a goods/service provider at the actual place with reference to the delivery address requested by the client, the client may make many orders subsequently on the network. Thus, the electronic commerce may be accomplished for a lot of goods or service regardless of their kind, thereby making the electronic commerce more conveniently.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An electronic commerce method for combined publicity according to the kind of goods or service by using a publicity item for combined publicity and gratitude expression, which is provided to a consumer when ordering or delivery is conducted according to a unique communication code and a detailed goods/service code set according to the kind of goods/service through a communication network system for connecting a central service provider server, member store terminals, client terminals and recipient terminals, the method comprising the steps of:
(a) interworking the central service provider server to a database storing goods/service information corresponding to the unique communication code and the detailed goods/service code and a database in which client information, member store information and recipient information are classified;
(b) reading corresponding goods/service information from the database interworked with the central service provider system with reference to a predetermined unique communication code or detailed goods/service code input from the client terminal connected to the central service provider server through the communication network;
(c) checking the goods/service information read by the client terminal, then if order-related information including an address for delivery is input for a specific goods/service, storing the input order-related information to a database classified by the client information and a database classified by the member store information which is referred in relation to the address for delivery of the order-related information respectively, and then transmitting the order-related information to a selected one of the member store terminals;
(d) the member store terminal delivering the ordered goods/service to the address for delivery of a designated recipient with reference to the order-related information and providing a publicity item for the combined publicity and gratitude expression together, and registering delivery completion information and publicity item-related information in a database interworked with the central service provider server; and
(e) the recipient terminal, which receives the publicity item for combined publicity and gratitude expression, registering information related to the publicity item in a database interworked with the central service provider server.

2. The electronic commerce method according to claim 1,
wherein, in the step (a), the goods/service database interworked with the central service provider server requires user certificating through the communication network so that information is updated only by a certificated member store within a predetermined range.

3. The electronic commerce method according to claim 1,
wherein, in the step (c), the order-related information includes a selected goods/service code, goods/service information related thereto, an address for delivery, client information, payment information and other selected information, which is related to single or multiple goods/service.

4. The electronic commerce method according to claim 3,
wherein the payment information of the order-related information includes information for a payment method using any of an on-line deposit without a banknote, a credit card, a mobile phone, and account-to-account money transfer.

5. The electronic commerce method according to claim 4,
wherein a payment according to the payment information of the order-related information is conducted in a way selected from the group consisting of a prepayment of an ordering person, a post-payment of an ordering person, and a post-payment of a recipient.

6. The electronic commerce method according to claim 1,
wherein the member store terminal is operated in an independent manager mode with a stand-alone interface which is interworked with the central service provider server and the client terminal in real time.

7. The electronic commerce method according to claim 1,
wherein the communication network system for connecting of the terminals including the central service provider server is a wire/wireless PSTN (Public Switched Telephone Network) system or a wire/wireless Internet system.

8. The electronic commerce method according to claim 7,
wherein, in case the communication network system is a wire/wireless PSTN system, the central service provider server is a chip included in a cellular phone, an ARS (Auto Responding System) or a manned integrated call center.

9. The electronic commerce method according to claim 1,
wherein the publicity item for combined publicity and gratitude expression is one selected from a tangible gift, an intangible service, a gift certificate, a discount coupon, and a lottery ticket for giving a prize to a winner.

10. The electronic commerce method according to claim 9, in case the publicity item for combined publicity and gratitude expression is a lottery ticket, further comprising the steps of, after the step (e):
(f) the central service provider server determining a winner who is going to receive a prize by random drawing of the publicity items provided by the member store, and then storing a lottery result in a database and announcing publicly the lottery result through a web page linked to the central service provider server; and
(g) awarding a prize to the winner when the winner presents the publicity item having a winning lottery number to the central service provider server or the member store by checking the lottery number stated in the publicity item.

11. The electronic commerce method according to claim 10,
wherein, in the step (g), in case the publicity item having a winning lottery number is registered in a database by a corresponding recipient, a differential prize is awarded rather than the other publicity items.

12. A computer-readable storing medium storing a program for executing the electronic commerce method defined in any of claims 1 to 11.
